(19) United States
(12) Patent Application Publication
(10) Pub. No.: US 2016/0037271 A1
(43) Pub. Date: Feb. 4, 2016

(54) INTER-PACKET HIBERNATION TIMING TO IMPROVE WIRELESS SENSITIVITY

(71) Applicants: Beau Jay Polinske, Minneapolis, MN (US); David Willey, Eden Prairie, MN (US)

(72) Inventors: Beau Jay Polinske, Minneapolis, MN (US); David Willey, Eden Prairie, MN (US)

(21) Appl. No.: 14/815,032

(22) Filed: Jul. 31, 2015

Related U.S. Application Data
(60) Provisional application No. 62/031,268, filed on Jul. 31, 2014.

(51) Int. Cl. H04R 25/00; H04W 52/28; H04L 29/06

(52) U.S. Cl. CPC H04R 25/554; H04L 69/28; H04W 52/287; H04R 2225/31; H04R 2225/55

(57) ABSTRACT

Embodiments of inter-packet hibernation timing to improve wireless sensitivity are generally described herein. A method for wireless communication can include receiving a transmission of a packet using a wireless transceiver of an electronic device, the wireless transceiver configured to automatically hibernate after receiving the packet, and setting a timer of the wireless transceiver. The method can include waking up the wireless transceiver upon expiration of the timer using a programmable window set in programmable steps, such that the wireless transceiver wakes up during a preamble of a next packet transmission, wherein while hibernating, the wireless transceiver can be configured to disable state machine functions used to recognize an incoming packet.

### CLAIM OF PRIORITY

This patent application claims the benefit of priority of U.S. Provisional Patent Application Ser. No. 62/031,268, titled “Systems and Methods for Inter-Packet Hibernation Timing to Improve Wireless Sensitivity,” filed on Jul. 31, 2014, which is hereby incorporated by reference herein in its entirety.

### FIELD OF THE INVENTION

Disclosed herein are devices and methods for inter-packet hibernation in hearing assistance devices, and in particular for improving wireless sensitivity in hearing assistance devices.

### BACKGROUND

Modern hearing assistance devices typically include digital electronics to enhance the wearer's experience. In the specific case of hearing aids, current designs employ digital signal processors rich in features. Their functionality is further benefited from communications, either from a remote source or from ear-to-ear for advanced processing. Thus, it is desirable to include wireless functionality for a hearing aid to allow for functions such as ear to ear synchronization, remote control, programming and configuration, streaming audio, bi-directional audio, etc. However, a radio frequency (RF) transceiver within the hearing aid consumes a significant amount of power for both transmission and reception of wireless signals. Current hearing aids can use too much power to communicate information, either from a remote device or from one aid to another.

When current hearing aids receive streaming information, such as voice or music, at a wireless transceiver, they can have problems with interference when waking up. Hearing aids may also experience a false detection of a packet or preamble in the streaming information before the intended packet actually arrives at the wireless transceiver. Some solutions attempt to raise a received signal strength indicator (RSSI) threshold. However, raising the RSSI threshold can result in a loss of sensitivity and range.

### SUMMARY

Disclosed herein are devices and methods for inter-packet hibernation timing to improve wireless sensitivity. In various embodiments, a method includes receiving a transmission of a packet using a wireless transceiver of an electronic device, the wireless transceiver configured to automatically hibernate after receiving the packet, and setting a timer of the wireless transceiver. The method can include waking up the wireless transceiver upon expiration of the timer using a programmable window set in programmable steps, such that the wireless transceiver wakes up during a preamble of a next packet transmission, wherein while hibernating, the wireless transceiver can be configured to disable state machine functions used to recognize an incoming packet.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates generally an electronic device in accordance with various embodiments of the present subject matter.

FIG. 2 illustrates generally a timing diagram depicting an unreliable sleep timer for a wireless transceiver.

FIG. 3 illustrates generally a timing diagram depicting inter-packet hibernation with a reliable sleep timer in accordance with various embodiments of the present subject matter.

FIG. 4 illustrates generally a process flow for wireless communication using inter-packet hibernation in accordance with various embodiments of the present subject matter.

FIG. 5 illustrates generally an example of a block diagram of a machine upon which any one or more of the techniques discussed herein can perform, in accordance with various embodiments of the present subject matter.

### DETAILED DESCRIPTION

The following detailed description of the present subject matter refers to subject matter in the accompanying drawings which show, by way of illustration, specific aspects and embodiments in which the present subject matter can be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

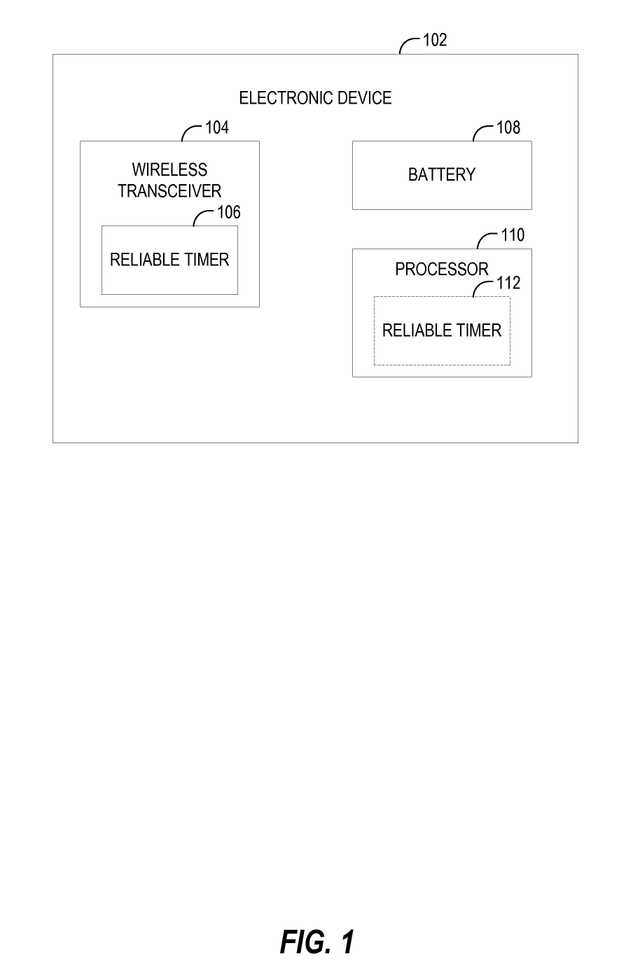

FIG. 1 illustrates generally an electronic device 102 in accordance with various embodiments of the present subject matter. The electronic device 102 can include a wireless transceiver 104, a battery 108, and a processor 110. The wireless transceiver 104 can include a reliable timer 106. The processor can optionally include a reliable timer 112. In an example, the electronic device 102 can include a hearing aid. The electronic device 102 can communicate with another device using the wireless transceiver 104. For example, the electronic device 102 can receive an audio packet from a device, such as phone, tablet, television, hearing aid, or the like.

A hibernate function can be used to reduce current consumption at the electronic device 102 while receiving a streamed content. For example, the processor 110 can receive a message (e.g., an rx_done interrupt) from the wireless transceiver 104 once a first packet has been received. An interrupt notifies the processor of an event that needs attention. The processor 110 can turn the wireless transceiver 104 off to save power. In an example, the processor 110 can run with a plus or minus 1 millisecond timer (not shown) that can be set in 1 millisecond increments. In this example, when the timer expires, the processor 110 can wake up the wireless transceiver 104. With an inaccurate timer on the processor 110 (e.g., the plus or minus 1 millisecond timer), the wireless transceiver 104 is woken up before a second, subsequent packet is received (or sent). This can create a vulnerability where interference can trigger a receive state machine before the second packet arrives. State machines are mathematical models of computation used to design computer programs and logic circuits. To mitigate the vulnerability, a previous technique included inflating a received signal strength indicator (RSSI) threshold above a necessary level to operate at sensitivity. This mitigation can reduce performance by 6 decibels (dB) or more.

In an example, the wireless transceiver 104 can be configured to receive a transmission of a packet and automatically hibernate after receiving the packet. While hibernating, the transceiver 104 can have its state machine functions used to recognize an incoming packet disabled. The transceiver 104 can set the timer and wake up upon expiration of the timer using a programmable window set in programmable steps, during a preamble of a next packet transmission. In another example, the wireless transceiver 104 can be configured to reduce current consumption from the battery during wireless communication when hibernating. In yet another example, the wireless transceiver 104 can be configured to operate at a link margin 6 decibels greater than when the state machine functions are enabled.

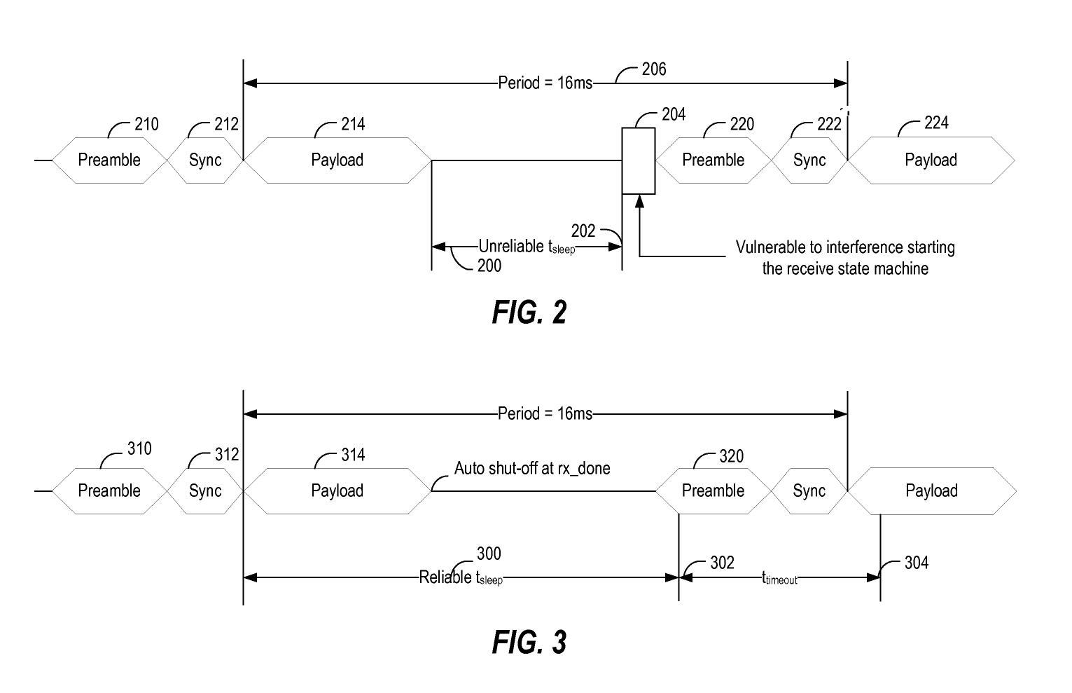

FIG. 2 illustrates generally a timing diagram depicting an unreliable sleep timer (e.g., the unreliable sleep timer 112 of the processor 110 of FIG. 1) for a wireless transceiver (e.g., wireless transceiver 104). The timing diagram shows timing for wireless communications between wireless devices, and illustrates a preamble 210, a sync pattern 212, and a payload 214 of a first packet. The diagram further shows a subsequent preamble 220, sync pattern 222 and payload 224 for a second packet, and shows a period 206 (e.g., 16 milliseconds) between the first 214 and second payloads 224 for the first and second packets. A hibernate function is implemented to reduce current consumption while streaming to hearing aids. This can be accomplished by the processor receiving an rx_done interrupt from the transceiver. The processor can turn the wireless transceiver (or receiver) off to save power for an unreliable sleep time (i.e., unreliable tₛₗₑₑₚ) 200. The unreliability is due to drift in the timer of the processor. For example, the processor can include a plus or minus 1 millisecond timer that can be set in 1 millisecond increments, as described above for FIG. 1. When the timer expires the wireless transceiver is woken up by the processor, at 202. Because of the inaccuracy of the unreliable timer of the processor, the radio is woken up at 202 before the next packet is received. This is a vulnerable time 204 where interference can trigger the receive state machine before the intended packet arrives. Waking the transceiver up before the preamble 220 of the second packet arrives leads to interference.

FIG. 3 illustrates generally a timing diagram depicting inter-packet hibernation with a known sleep timer (e.g., the reliable timer 106 of FIG. 1) in accordance with various embodiments of the present subject matter. The timing diagram shows timing for wireless communications between wireless devices. In an example, a wireless device can include a hearing aid. In another example, a wireless device, such as a hearing aid, can receive a stream of information from another wireless device, such as a mobile device (e.g., a mobile phone, tablet, mp3 player, etc.), a computer, or the like.

In an example, a reliable timer can be added to the wireless transceiver to automatically hibernate for a period after receiving a packet. The period can include a reliable sleep time (reliable tₛₗₑₑₚ) 300. In an example, the reliable sleep time 300 is predetermined according to a specification, a preamble (e.g., preamble 310), or a sync (e.g., sync 312). In an example, the wireless transceiver can wake up at 302 in the preamble 320 of the second packet. For example, the wireless transceiver can wake up in a plus or minus 10 microsecond window set in plus or minus 20 microsecond steps. Other windows and step periods can be used without departing from the scope of the present subject matter. The wireless transceiver will go back to sleep after a programmable timeout 304 if a preamble is not received, in various embodiments. In various embodiments, the processor can receive a message (e.g., an rx_done interrupt) from the wireless transceiver once a first packet has been received (at end of payload 314), and the processor can automatically turn the wireless transceiver off to save power.

Using the reliable timer on the wireless transceiver and the ability to wake up during the preamble 320, the wireless transceiver can disable a state machine function (or all state machine functions) used to recognize an incoming packet during the hibernation period. For example, a preamble detect that would be required in the setup of FIG. 2 with the unreliable sleep timer can be disabled in the setup of FIG. 3 with the reliable timer on the wireless transceiver configured to have a reliable sleep time to wake up the wireless transceiver in the preamble 320. The preamble detect can be disabled if the wireless transceiver has a reliable sleep timer since the wireless transceiver will be woken up in the preamble 320. In another example, the wireless transceiver can disable the RSSI threshold detection state machine function that is used in the setup of FIG. 2 to determine if the wireless transceiver is in the preamble 320. By disabling the RSSI threshold detection, the wireless transceiver can operate at sensitivity (e.g., at a 12 dB signal-to-noise ratio (SNR)) with the reliable sleep timer. In yet another example, the wireless transceiver can gain 6 dB or greater link margin relative to wireless transceiver using the setup of FIG. 2. The reliable sleep timer can increase the range and sensitivity of the wireless transceiver and continue to operate in interference, when the intended signal is a specified amount above the noise and/or interference (e.g., 12 dB, in an example). The greater than 6 dB improvement of sensitivity equates to a doubling of the range in the wireless transceiver of the FIG. 3 setup over the FIG. 2 setup. The improved sensitivity can allow the wireless transceiver to operate in an area of wireless interference.

In an example, a backup system can be implemented to protect against instances where a packet is lost, despite the reliable sleep timer. If a packet is lost, a timeout can be set and if a sync_detect (a signal indicating that payload is about to begin) is not passed to the processor the normal packet recognition can be enabled to sense the next packet. For example, the preamble detect can enabled if the sync_detect is not passed to the processor.

Various examples of the present subject matter provide an automatic hibernate function without processor intervention. The hibernate function removes preamble detection and/or RSSI threshold detection to recognize an incoming packet, in various examples. In another example, the timer can be a processor timer instead of a timer on the wireless transceiver, if a consistent processor timer is available. In this example, the processor timer can act as the reliable sleep timer and control waking up the wireless transceiver.

In an example, the wireless communication includes a bidirectional link with feedback from a transmitter (such as transceiver 104) when a packet is missed. In the setup of FIG. 2, the wireless transceiver stays awake and enables preamble detection to catch the next packet after the packet is missed. In an example with the setup of FIG. 3, the wireless transceiver can hibernate and does not need to stay awake to receive a sync word. Then the wireless transceiver can wake up when the next preamble is expected using the reliable timer. The transmitter (e.g., master) can recognize that there was no expected reply and increase the preamble length to ensure the receiver (e.g., slave) catches the next preamble on its next wake up, in an example. One reason to increase preamble length is to accommodate clock mismatch between the transmitter and receiver.

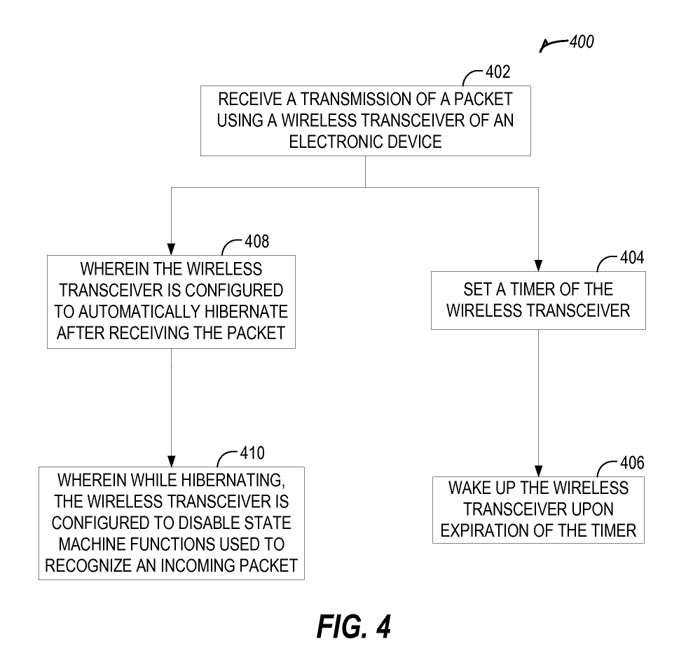

FIG. 4 illustrates generally a process flow 400 for wireless communication using inter-packet hibernation in accordance with various embodiments of the present subject matter. The process flow 400 includes an operation 402 to receive a transmission of a packet using a wireless transceiver (e.g., the wireless transceiver 104 of FIG. 1) of an electronic device (e.g., the electronic device 102 of FIG. 1). In an example, the electronic device includes a hearing aid. In another example, the electronic device includes a battery (e.g., the battery 108 of FIG. 1). In this example, the wireless transceiver can be configured to reduce current consumption from the battery during wireless communication when hibernating. In yet another example, the transmission of the packet can include a signal-to-noise ratio of greater than 12 dB (decibels).

The process flow 400 includes an operation 404 to set a timer of the wireless transceiver. The process flow 400 includes an operation 406 to wake up the wireless transceiver upon expiration of the timer (e.g., the reliable timer 106 of FIG. 1). In an example, waking up the wireless transceiver can include waking up the wireless transceiver upon expiration of the timer using a programmable window set in programmable steps. The programmable window can include a window of plus or minus 10 microseconds and the programmable steps can include steps of plus or minus 20 microseconds.

The process flow 400 includes an operation 408 wherein the wireless transceiver is configured to automatically hibernate after receiving the packet. The process flow 400 includes an operation 410 wherein while hibernating, the wireless transceiver is configured to disable state machine functions used to recognize an incoming packet. In an example, a state machine function can include an RSSI threshold detection or a preamble detection. In another example, when the state machine functions are disabled, the wireless transceiver can be configured to operate at a link margin of up to 6 dB greater than when the state machine functions are enabled.

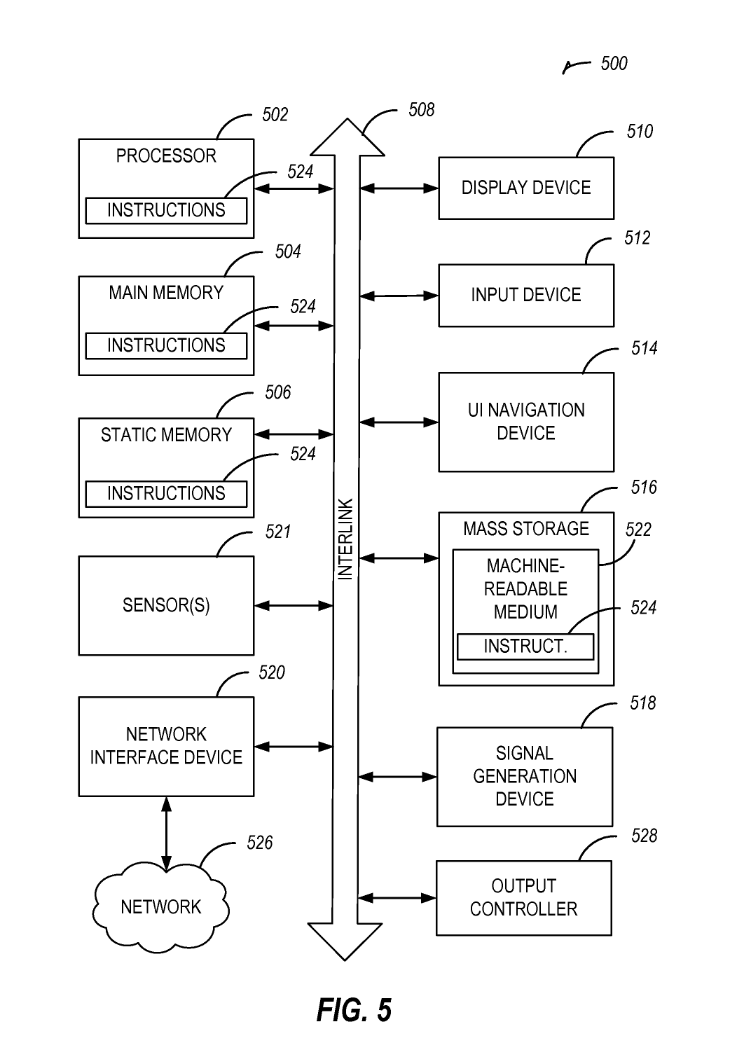

FIG. 5 illustrates generally an example of a block diagram of a machine 500 upon which any one or more of the techniques discussed herein can perform in accordance with various embodiments of the present subject matter. In various embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can include processor 110 in FIG. 1 in various embodiments. The machine 500 can be a hearing assistance device such as a hearing aid, a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include configurable execution units (e.g., transistors, circuits, etc.) and a computer readable medium containing instructions, where the instructions configure the execution units to carry out a specific operation when in operation. The configuring can occur under the direction of the executions units or a loading mechanism. Accordingly, the execution units are communicatively coupled to the computer readable medium when the device is operating. In this example, the execution units can be a member of more than one module. For example, under operation, the execution units can be configured by a first set of instructions to implement a first module at one point in time and reconfigured by a second set of instructions to implement a second module.

Machine (e.g., computer system) 500 can include a hardware processor 502 (e.g., a central processing unit (CPU), a graphics processing unit (GPU), a hardware processor core, or any combination thereof), a main memory 504 and a static memory 506, some or all of which can communicate with each other via an interlink (e.g., bus) 508. The machine 500 can further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 can be a touch screen display. The machine 500 can additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 can include a machine readable medium 522 that is non-transitory on which is stored one or more sets of data structures or instructions 524 (e.g., software) embodying or utilized by any one or more of the techniques or functions described herein. The instructions 524 can also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 can constitute machine readable media.

While the machine readable medium 522 is illustrated as a single medium, the term “machine readable medium” can include a single medium or multiple media (e.g., a centralized or distributed database, and/or associated caches and servers) configured to store the one or more instructions 524.

The term “machine readable medium” can include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples can include solid-state memories, and optical and magnetic media. Specific examples of machine readable media can include: nonvolatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 can further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques.

Hearing assistance devices typically include at least one enclosure or housing, a microphone, hearing assistance device electronics including processing electronics, and a speaker or “receiver.” Hearing assistance devices can include a power source, such as a battery. In various embodiments, the battery can be rechargeable. In various embodiments multiple energy sources can be employed. It is understood that in various embodiments the microphone is optional. It is understood that in various embodiments the receiver is optional. It is understood that variations in communications protocols, antenna configurations, and combinations of components can be employed without departing from the scope of the present subject matter. Antenna configurations can vary and can be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains can be employed to adjust the hearing assistance device output to a wearer's particular hearing impairment. The processor can be a digital signal processor (DSP), microprocessor, microcontroller, other digital logic, or combinations thereof. The processing can be done by a single processor, or can be distributed over different devices. The processing of signals referenced in this application can be performed using the processor or over different devices. Processing can be done in the digital domain, the analog domain, or combinations thereof. Processing can be done using subband processing techniques. Processing can be done using frequency domain or time domain approaches. Some processing can involve both frequency and time domain aspects. For brevity, in some examples drawings can omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which can or cannot be explicitly shown. Various types of memory can be used, including volatile and nonvolatile forms of memory. In various embodiments, the processor or other processing devices execute instructions to perform a number of signal processing tasks. Such embodiments can include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

Various embodiments of the present subject matter support wireless communications with a hearing assistance device. In various embodiments the wireless communications can include standard or nonstandard communications. Some examples of standard wireless communications include, but not limited to, Bluetooth™, low energy Bluetooth, IEEE 802.11 (wireless LANs), 802.15 (WPANs), and 802.16 (WiMAX). Cellular communications can include, but not limited to, CDMA, GSM, ZigBee, and ultra-wideband (UWB) technologies. In various embodiments, the communications are radio frequency communications. In various embodiments the communications are optical communications, such as infrared communications. In various embodiments, the communications are inductive communications. In various embodiments, the communications are ultrasound communications. Although embodiments of the present system can be demonstrated as radio communication systems, it is possible that other forms of wireless communications can be used. It is understood that past and present standards can be used. It is also contemplated that future versions of these standards and new future standards can be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fibre-channel, Firewire or 1394, InfiniBand, or a native streaming interface. In various embodiments, such connections include all past and present link protocols. It is also contemplated that future versions of these protocols and new protocols can be employed without departing from the scope of the present subject matter.

In various embodiments, the present subject matter is used in hearing assistance devices that are configured to communicate with mobile phones. In such embodiments, the hearing assistance device can be operable to perform one or more of the following: answer incoming calls, hang up on calls, and/or provide two way telephone communications. In various embodiments, the present subject matter is used in hearing assistance devices configured to communicate with packet-based devices. In various embodiments, the present subject matter includes hearing assistance devices configured to communicate with streaming audio devices. In various embodiments, the present subject matter includes hearing assistance devices configured to communicate with Wi-Fi devices. In various embodiments, the present subject matter includes hearing assistance devices capable of being controlled by remote control devices.

It is further understood that different hearing assistance devices can embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter can be employed in hearing assistance devices, such as headsets, headphones, and similar hearing devices.

The present subject matter is demonstrated for hearing assistance devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices can include devices that reside substantially behind the ear or over the ear. Such devices can include hearing assistance devices with receivers associated with the electronics portion of the behind-the-ear device, or hearing assistance devices of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard fitted, open fitted and/or occlusive fitted. It is understood that other hearing assistance devices not expressly stated herein can be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for wireless communications, comprising:
receiving a transmission of a packet using a wireless transceiver of an electronic device, the wireless transceiver configured to automatically hibernate after receiving the packet;
setting a timer of the wireless transceiver; and
waking up the wireless transceiver upon expiration of the timer using a programmable window set in programmable steps, such that the wireless transceiver wakes up during a preamble of a next packet transmission, wherein while hibernating, the wireless transceiver is configured to disable state machine functions used to recognize an incoming packet.

2. The method of claim 1, wherein the electronic device includes a hearing aid.

3. The method of claim 2, wherein the hearing aid includes a battery.

4. The method of claim 3, wherein the wireless transceiver is configured to reduce current consumption from the battery during wireless communication when hibernating.

5. The method of claim 1, wherein the programmable window includes a window of plus or minus 10 microseconds and the programmable steps include steps of plus or minus 20 microseconds.

6. The method of claim 1, wherein the transmission of the packet includes a signal to noise ratio of at least 12 decibels.

7. The method of claim 1, wherein the wireless transceiver is configured to operate at a link margin 6 decibels greater than when the state machine functions are enabled.

8. The method of claim 7, wherein a state machine function of the disabled state machine functions includes an RSSI threshold detection function.

9. The method of claim 7, wherein a state machine function of the disabled state machine functions includes a preamble detection.

10. At least one machine-readable medium including instructions for receiving information, which when executed by a processor of the machine, cause the machine to:
receive a transmission of a packet using a wireless transceiver, the wireless transceiver configured to automatically hibernate after receiving the packet;
set a timer of the wireless transceiver; and
wake up the wireless transceiver upon expiration of the timer using a programmable window set in programmable steps, such that the wireless transceiver wakes up during a preamble of a next packet transmission, wherein while hibernating, the wireless transceiver is configured to disable state machine functions used to recognize an incoming packet.

11. The machine-readable medium of claim 10, wherein the machine includes a hearing aid.

12. The machine-readable medium of claim 11, wherein the hearing aid includes a battery.

13. The machine-readable medium of claim 12, wherein the wireless transceiver is configured to reduce current consumption from the battery during wireless communication when hibernating.

14. The machine-readable medium of claim 10, wherein the programmable window includes a window of plus or minus 10 microseconds and the programmable steps include steps of plus or minus 20 microseconds.

15. The machine-readable medium of claim 10, wherein a state machine function of the disabled state machine functions includes an RSSI threshold detection function.

16. The machine-readable medium of claim 10, wherein a state machine function of the disabled state machine functions includes a preamble detection.

17. An electronic device comprising:
a wireless transceiver, including a timer, configured to:
receive a transmission of a packet of wireless communication;
automatically hibernate after receiving the packet;
while hibernating, disable state machine functions used to recognize an incoming packet;
set the timer; and
wake up upon expiration of the timer using a programmable window set in programmable steps, during a preamble of a next packet transmission.

18. The electronic device of claim 17, wherein the electronic device includes a hearing aid, and further comprising a battery.

19. The electronic device of claim 18, wherein the wireless transceiver is configured to reduce current consumption from the battery during wireless communication when hibernating.

20. The electronic device of claim 17, wherein the wireless transceiver is configured to operate at a link margin 6 decibels greater than when the state machine functions are enabled.

21. The electronic device of claim 20, wherein a state machine function of the disabled state machine functions includes an RSSI threshold detection function.

22. The electronic device of claim 20, wherein a state machine function of the disabled state machine functions includes a preamble detection.
